(19) United States
(12) Patent Application Publication
(10) Pub. No.: US 2020/0042588 A1
(43) Pub. Date: Feb. 6, 2020

(54) User Interface Tools and Methods Facilitating Data Transformations and Coding

(71) Applicants: Dmitry Sagalovskiy, New York, NY (US); Yaroslav Sagalovskiy, Washington, DC (US); William Jacob Streb, Atlanta, GA (US)

(72) Inventors: Dmitry Sagalovskiy, New York, NY (US); Yaroslav Sagalovskiy, Washington, DC (US); William Jacob Streb, Atlanta, GA (US)

(21) Appl. No.: 16/531,006

(22) Filed: Aug. 2, 2019

Related U.S. Application Data
(60) Provisional application No. 62/714,612, filed on Aug. 3, 2018.

(51) Int. Cl. G06F 17/24; G06F 3/0481; G06F 17/22; G06F 8/41

(52) U.S. Cl. CPC G06F 17/246; G06F 8/427; G06F 17/2247; G06F 3/04817

(57) ABSTRACT

User interface techniques facilitating computer system coding and data transformations are provided. In some aspects of the invention, a data transformation facilitating tool is provided, which allows a user to perform complex, multi-step transformations of data held within a set of cells of a spreadsheet, without using additional cells of the spreadsheet. In other aspects of the invention, a 2-way coding and presentation assessment tool is provided, which allows a user to alter underlying software code for a spreadsheet program by manipulating a graphical component of the spreadsheet program, and vice-versa, using a parallel coding window, which is simultaneously presented to the user.

### CROSS-REFERENCE TO RELATED APPLICATION

This application claims priority to U.S. Provisional Application No. 62/714,612, filed Aug. 3, 2018, titled “User Interface Tools Facilitating Coding and Transformations,” the contents of which are hereby incorporated by reference into the present application in their entirety, as if fully set forth herein.

### FIELD OF THE INVENTION

The present invention relates to the field of user interface tools, implemented on computer hardware and software. The present invention also relates to the field of mathematics and spreadsheet systems for performing complex calculations.

### BACKGROUND

Spreadsheet hardware and software systems for managing alphanumeric data have been commercially available for many years. Several spreadsheet programs, such as Microsoft Excel and Google Sheets, create graphical user interfaces (“GUI's”) that permit users to enter and manage data in a grid format, divided by vertical columns and horizontal rows (a.k.a., a “table”). In these GUI's, an array of data entry and presentation fields, known as “cells,” is created. Depending on the program, various mathematical or other operations may be applied to the data entered or appearing within the cells—sometimes, through the entry of simplified sequences of software code and data references called “formulas” within the same or other cells managed by the program. Typically, these formulas allow users to apply arithmetic or other functions to the data. Generally, once a formula is entered within a cell, the result of the application of that formula (rather than the formula itself, or referenced source data processed by the formula) will then be presented in that cell. However, the formula itself, and the source data, may still be reviewed in various ways. For example, by viewing the “formula bar,” near the top of the Excel GUI, and highlighting a cell, the underlying formula, if any, can be seen.

Such programs also aid users in performing enhancements or other alterations of the data's presentation in a variety of ways, in virtually unlimited possible steps (hereinafter, data “transformations”). For example, in Excel, a user can change the format of a number presented within a cell to include or eliminate redundant or unnecessarily presented data, such as insignificant figures or repetitive spacing. Typically, these transformations may require the use of several ancillary, neighboring cells within the grid—particularly with more complex sequences of operations.

Some spreadsheet programs allow users to perform more sophisticated software coding than is possible with the user-friendly code references of formulas. Excel includes a code editor, for instance, to create such sophisticated software in the Visual Basic for Applications programming language (“VBA” or “Visual Basic”). Entering VBA code into the Excel Code Editor, a user can automate a large series of operations on data recorded in the cells. Excel also allows for the creation of custom operations with new code references, which can then be included in more simplified formulas incorporating the new references.

It should be noted that some of the disclosures set forth as background, such as, but not limited to, the above language under the heading “Background,” do not relate exclusively to prior art and the state of the art in the field(s) of the invention, and should not be construed as an admission with respect thereto.

### SUMMARY OF THE INVENTION

User interface techniques for facilitating the entry of software code within spreadsheet programs are provided. In some aspects of the invention, a transformation facilitating user interface tool is provided, in which a user may create and apply complex, multiple-stage data transformations within a set of cells of a spreadsheet, without using additional cells of the spreadsheet, and by using simple gestures. In other aspects of the invention, a 2-way coding and presentation assessment tool is provided, which allows a user to alter underlying software code for a spreadsheet program by manipulating a graphical component of the spreadsheet program, and vice-versa, using a parallel coding window, which is simultaneously presented to the user.

The techniques may include methods and systems, which systems may comprise computer hardware and software, including non-transitory machine-readable media with executable instructions. When executed by a computer system, the instructions may cause the systems to carry out any or all of the methods set forth herein.

These and other aspects of the invention will be made clearer below, in other parts of this application. This Summary, the Abstract, and other parts of the application, are for ease of understanding only, and no part of this application should be read to limit the scope of the invention, whether or not it references matter in any other part.

### BRIEF DESCRIPTION OF THE DRAWINGS

FIG. 1 depicts example data processing and presentation tools, within a user interface, and presented on example computer display hardware, in accordance with some embodiments of the present invention.

FIG. 2 depicts some of the same example data and data presentation transformation tools set forth in FIG. 1, but according to some embodiments with a transformation facilitating tool in an expanded format, hovering over example cells of a spreadsheet to transform data held therein.

FIG. 3 depicts some of the same example data and data presentation transformation tools set forth in FIG. 2, with a transformation facilitating tool in an expanded format, hovering over the same example cells of a spreadsheet, with several formulae entered into formula entry fields, in accordance with some embodiments of the present invention.

FIG. 4 depicts some of the same example data and data presentation transformation tools set forth in FIGS. 2 and 3, with a transformation facilitating tool in an expanded format, hovering over the same example cells of a spreadsheet, with the several example formulae executed by a control system, in accordance with some embodiments of the invention.

FIG. 5 depicts some of the same example data and data presentation transformation tools set forth in FIG. 4, above, with a transformation facilitating tool in an even further expanded format, in accordance with some embodiments of the invention.

FIG. 6 depicts some of the same example data and presentation transformation tools within a user interface as set forth above, in reference to FIG. 1, but with a 2-way coding and presentation assessment tool expanded and presented to a user, in accordance with some embodiments of the invention.

FIG. 7 depicts some of the same example data and presentation transformation tools within a user interface as set forth above, in reference to FIG. 6, as a user is actuating a parallel coding window of a 2-way coding and presentation assessment tool, in accordance with some embodiments of the invention.

FIG. 8 depicts some of the same example data and presentation transformation tools within a user interface as set forth above, in reference to FIGS. 6 and 7, displaying an example subsequent result when a user enters invalid code within the parallel coding window, according to some embodiments of the invention.

FIG. 9 depicts some of the same example data and presentation transformation tools within a user interface as set forth above, in reference to FIGS. 6-8, above, along with a subsequent result when a user has corrected or completed an erroneous code entry set forth in FIG. 8, above, in accordance with some embodiments of the invention.

FIG. 10 depicts the same example data and presentation transformation tools within a user interface as set forth above, in reference to FIGS. 6-9, above, along the implementation of an example helper function within a 2-way coding view of some user interface embodiments of the present invention.

FIG. 11 is a structural diagram of some example system components, in accordance with some embodiments of the invention, which may be used to carry out 2-way coding aspects, in accordance with some embodiments set forth above.

FIG. 12 is a schematic block diagram of some elements of an example control system that may be used to implement various aspects of the present invention, some of which aspects are described in reference to FIGS. 1-11 and 13 of this application, in accordance with some embodiments of the invention.

FIG. 13 is a process flow diagram, setting forth several example steps that may be undertaken by a control system (such as the example control system set forth above, in reference to FIG. 12) implementing some aspects of the present invention.

FIG. 14 depicts example data processing and presentation tools, similar in nature to some tools set forth above, but with a different form factor, in accordance with some embodiments of the present invention.

### DETAILED DESCRIPTION OF THE INVENTION

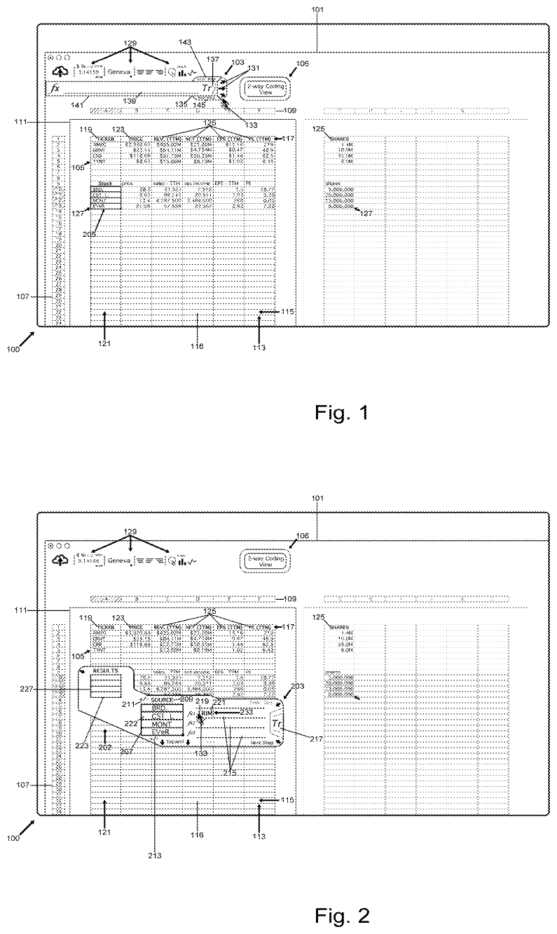

FIG. 1 depicts some example data processing and presentation tools, within a larger example user interface 101, and presented on example computer display hardware 100, within or controlled by a control system in accordance with some embodiments of the present invention. More specifically, those data processing and presentation tools include a data transformation facilitating tool 103, and a 2-way coding and presentation assessment tool 106. As explained in greater detail below, each of these data presentation and transformation tools are preferably created and/or controlled by specialized computer hardware, such as the example control system set forth below, in reference to FIG. 12, running one or more data spreadsheet software programs, examples of which are set forth in this application. As will be apparent to those of ordinary skill in the art to which the present invention relates, a wide range of data management and spreadsheet software programs (“spreadsheet programs”) may include or be modified programmatically to include or incorporate the user interface techniques of the present invention, as set forth in this application. The mention or discussion of any specific spreadsheet program within this application is for illustration purposes only, and in no way limits the scope of the present invention. More generally, the exact detailed embodiments provided throughout this application, including the devices and GUI elements set forth in the figures and discussed in detail in this application are, of course, examples, and not limiting. Rather, these embodiments are intended only as a reasonable set of possible example structures, substructures, materials, methods, steps and other aspects of the present invention, among virtually infinite and innumerable possibilities for carrying out the present invention, to ease comprehension of the disclosure, as will be readily apparent to those of ordinary skill in the art. For example, the description of one particular order, number or other arrangement of any aspects of the present invention set forth herein is illustrative, not limiting, and all other possible orders, numbers, etc., are also within the scope of the invention, as will be so readily apparent. Any aspect of the invention set forth herein may be included with any other aspect or embodiment, as well as any aspects known in the art, in any number, order, arrangement, or alternative configuration, while still carrying out, and falling within, the scope of the invention.

Generally speaking, data transformation facilitating tool 103 aids the user in performing complex, multi-step data and data presentation changes (a.k.a. “transformations”), using formulas applied within a spreadsheet program. Ordinarily, without the present invention, such transformations may require the use of many cells or sets of cells within a spreadsheet, or multiple spreadsheets, managed by a spreadsheet program, as will be discussed further below. For example, a user of the spreadsheet program may maintain a set of data 105, as a database related to particular investments, within cell positions A1 through G5 (as indicated by vertical numerical Cartesian coordinate indicators 107 and horizontal alphabetical Cartesian coordinate indicators 109). Those data may be arranged within a spreadsheet 111 as a table, constructed with columns, such as example column 113, and rows, such as example row 115, of cells, such as example cell 116, which cells are configured to hold, process and present the data. Column headings are presented within cells in an example top row 117, helping any user of spreadsheet 111 navigate the data sorted immediately below them. For example, column heading 119, “TICKER,” indicates that the data appearing directly below it within the column below (column 121), in cells corresponding with positions A2 through A5, are the (in this example, fictitious) unique identifier for each of 5 particular equity securities on a public exchange (such as the NASDAQ or NYSE). Progressing from left-to-right, the next example column heading 123, “PRICE,” indicates that the data immediately below holds numbers corresponding with the price of a share of stock for each security, in cell positions B2-B5 of the spreadsheet 111. As can be seen, headings 119 and 123, and each of the remaining example headings 125 in top row 117, are in a bolded and all upper-case font format, meaning that the text is darker and larger than a standard or default font format, appearing elsewhere in spreadsheet 111, and that every letter is in an upper-case style (a.k.a., with capital letters). As also can be seen, the data below column heading 119 in column 121 is also in an all upper-case format, but not in a bolded format. Some other numerical data within set of data 105 are in a U.S. Dollar currency format, meaning that a leading dollar sign ($) indicator precedes the numerical data in each cell, indicating that the data relates to a money value. In addition, a floating point indicator (i.e., a decimal point) is provided in some data presented in the cells, with one or two decimal places (the tenths and hundredths place, assuming that a decimal system is used) to the right shown, depending on the particular column in which the set of data 105 appear. The formatting that appears in set of data 105, as described above and as further appears in the figure, may be formatting that a user has created, using various tools of the spreadsheet program, and will be referred to hereinafter as the “desired formatting.”

Again by way of example, when later creating or importing a new data set added to spreadsheet 111 after set of data 105, such as the example new or “raw” data set shown as set of data 127, a user may wish to alter the presentation of set of data 127 to more closely match the desired formatting shown in set of data 105. To do so, ordinarily, such a user might enter formulas in other cells of spreadsheet 111, apart from the cells occupied by set of data 105 and set of data 127, to process those data and perform operations to change the presentation of those data, and make those data conform more closely to the desired formatting, discussed above. In some such embodiments, a new presentation of such data, and/or some other intermediate data products, would then appear in such other cells of spreadsheet 111, as the result of such formulas. Often, still more cells of spreadsheet 111, in addition to those previously-used intermediate cells, would also be required, for separate, additional processing steps, which again yield new presentations of the data based on formulas applied to intermediate products, and perhaps creating additional intermediate products, requiring additional sets of spreadsheet cells, and so on. Instead, in accordance with aspects of the present invention, a user may use data transformation facilitating tool 103 to achieve such data processing and presentation results in a better way, as will be discussed in greater detail below.

Data transformation facilitating tool 103 is shown embedded within, and/or as a part of, user interface 101, just below and appended to several other user interface tools 129, in a linear arrangement, which may be referred to as a “toolbar,” in accordance with some embodiments. (Again, the appearance and position of transformation facilitating tool 103, or any other embodiment shown in the figure, is only an example of some aspects of the invention.) In some aspects of the invention, transformation facilitating tool 103 may be expanded to a larger form factor, for example, by clicking on expansion arrows, such as the examples shown as expansion arrows 131 (as pictured), or by pressing a shortcut key of a keyboard input device of a control system implementing aspects of the invention, in which case transformation facilitating tool 103 moves into a position within or hovering over at least part of spreadsheet 111 (a “hovering position” and “expanded format”). (An example execution of an expanded format and hovering position will be discussed in greater detail below, in reference to FIGS. 2 et seq.) In other aspects of the invention, transformation facilitating tool 103 may be manually resized or repositioned by a user, in accordance with user interface resizing and repositioning techniques known in the art (e.g., clicking once and holding on the transformation facilitating tool 103 with a “pointer,” such as example pointer 133, and “dragging” to moving it, or by clicking, holding and dragging corners of the user interface aspect to resize it.) In any event, transformation facilitating tool 103 is shown in a more condensed, smaller format in FIG. 1, which will be referred to as the condensed format 135 (or “toolbar format”) of transformation facilitating tool 103.

In either format—the toolbar format or the expanded format discussed above, and discussed further below—transformation facilitating tool 103 may execute all of a series of separate formulas, in serial order, if they have been entered by the user within data entry field(s) of transformation facilitating tool 103, after highlighting cells containing data to be processed by the formulas (e.g., by selecting them within the spreadsheet using pointer 133). In some embodiments, the transformation facilitating tool 103 will so execute all of such a series of formulas upon the user activating a command-initiating control of the transformation facilitating tool 103. For example, in some embodiments, transformation facilitating tool 103 is configured with a user interface button labeled “Tr,” for “Transformation”—namely, transform button 137, which serves as such a command-initiating control. In some such embodiments, a user may so activate such a command-initiating control by “clicking on” such a button or other user interface aspect.

It should be noted that, in some embodiments, such transformations are applied in another manner. For example, in some embodiments, a user may apply such transformations after entering them, merely by pressing the “enter” or “return” button of a keyboard input device of the control system, which pressing is a different form of command-initiating control. In some embodiments, a user may apply such transformations after entering them through other simple gestures sensed by the control system implementing the invention, which gestures are a different form of command-initiating control. In some embodiments, the transformation tool enables such another manner of applying transformations, and such other forms of command-initiating controls along with enabling the application of transformations using a pointer. In some other embodiments, some one but not all of such methods of application of transformations are enabled. In some other embodiments, all of such alternative methods of application of transformations are enabled.

After such formulas are run, the results (a.k.a. the “output data”) of all of the formulas are then shown, as applied to the data in each of the highlighted cells, and the results with respect to each of the highlighted cells may then be presented in place of the data previously shown in the highlighted cells. The data previously shown in the highlighted cells is still stored by the control system, but no longer presented, after executing the formulas using the transformation facilitating tool 103 (although, in some embodiments, as discussed below, other views of the original data and resulting presentation, may be viewed simultaneously.) In some embodiments, the data previously shown is no longer presented by “hiding” it, meaning that another user interface aspect, such as the output data, is placed over it (at a higher z-access position) and preventing a user's view of it.

In some embodiments, in the condensed toolbar format pictured in FIG. 1 as condensed format 135, it is possible for a user to so enter such a series of formulas, one-by-one, within a single fillable data entry field 139 shown in formula entry window 141. Due to size limitations, in some embodiments, fillable data entry field 139 may only be able to accept one formula at a time. In some other embodiments, fillable data entry field 139 may be able accept multiple formulas at a time. For example, in some such embodiments, only two or three formulas at a time may be accepted in fillable data entry field 139. In some such embodiments, formulas must be smaller than a particular size limit to be accepted in fillable data entry field 139. In some embodiments, multiple formulas entered in fillable data entry field 139 must be entered with separators, such as semicolons, between them.

However, in some embodiments the user can move up or down through the series of such fillable data entry fields, each holding one of a series of such functions, showing the next function field above or below the field presently shown in window 139, by using scrolling. For example, in some embodiments, a user may so scroll, upwards and downwards through the series, by using previous step button 143 and next step button 145, respectively. If so, despite the fact that only one formula (or a few small, concatenated formulas) may appear at a time in window 141, pressing transform button 139 results in each of them being carried out, in the sequence given by the user, from top-to-bottom, in some embodiments. However, in other embodiments of the invention, a user may designate only some of the formulas to be carried out. In some embodiments, a user may designate alternate sequences for carrying out such formulas. In some embodiments, a user may use transformation facilitating tool 103 to carry out formulas with respect to particular cells, within the set of highlighted cells, designated by the user. Some of these aspects, and still others, will be better understood in reference to the additional, following figures.

FIG. 2 depicts some of the same example data and data presentation transformation tools set forth in FIG. 1, but according to some embodiments with a transformation facilitating tool, now shown as example transformation facilitating tool 203, in an expanded format, hovering over example selected and highlighted cells of spreadsheet 111 to transform data held within some cells of spreadsheet 111. In some embodiments of the invention, to create the user interface features and configuration set forth in this figure, a user viewing the user interface 101 shown in FIG. 1, above, first actuated the expansion arrows 131 pictured in that figure, or otherwise caused (e.g., by pressing a keyboard shortcut) the expansion and repositioning of transformation facilitating tool 103 (now numbered 203, to signify its different, expanded profile and position in the present figure), hovering directly over the set of cells 205 that had been previously selected (and highlighted) by a user—namely, cells A10 through A13.

In some aspects of the invention, expanded, hovering transformation facilitating tool 203 covers and blocks from view (e.g., by having a higher z-axis coordinate within a visual presentation layering palette maintained by the program than) the cells of spreadsheet 111 directly beneath it, with the exception of the set of cells 205 that had been highlighted by the user (cells A10 through A13). In some embodiments, such as the embodiments shown, the data present within those cells can still be seen, however, within an original source data window 207, noted by the heading label 209, which reads “SOURCE.” In some embodiments of the invention, a user may add cells and data from within them from above and below set of cells 205, in the same column, to the selected, highlighted set of cells 205 and source data within them and window 207 (corresponding with part of column 202 of the spreadsheet), by actuating add/remove cells button 211 and add/remove cells button 213. In some embodiments, however, such cells and data may be so added with a keyboard command, gesture or other user command, in various embodiments. In some embodiments, any user interface button or other GUI tool provided in the present application may be replaced or supplemented with a keyboard shortcut. In some embodiments, any user interface button or other GUI tool provided in the present application may be replaced or supplemented with a gesture. In still other embodiments, any user interface button or other GUI tool provided in the present application may be replaced or supplemented with any suitable command or input method or tool known in the art to which the present application relates. In any event, as shown in the figure, the previous formula entry window 141, has been replaced by a larger set of formula entry fields 215, each of which is configured to accept the entry of a separate formula for transforming the source data in window 207, to be serially executed upon pressing the transform button, now also shown in an expanded form as transform button 217. For example, in the first of those fields, formula entry field 219, a user is entering a relatively short formula 221 with a single functional command, “TRIM,” as shown by a flashing bar-style cursor 233 immediately afterward. In some embodiments, and as discussed further below, the control system implementing user interface 101 and transformation facilitating tool 203 periodically tests (e.g., after each term is entered, followed by entry of a space) whether a solvable formula has been entered in any of formula entry field(s) 215, and, if so, renders tentative results (such embodiments being discussed further, below). In some such embodiments, the tentative results are rendered in a particular distinctive color or other indication scheme to indicate that it is a tentative result. In some embodiments, the control system implementing user interface 101 and/or transformation facilitating tool 203 renders tentative results in a particular distinctive color or other indication scheme to indicate if errors have been detected in the parsing or validation of the formula. When applied, the TRIM function, as used in some spreadsheet programs, is a data housekeeping function that causes certain blank spaces within data (e.g., between characters) to be eliminated, and not presented. For example, because cell 222, corresponding with highlighted, selected cell A11, within the Cartesian coordinate system of spreadsheet 111, of previously highlighted column 202 (now shown as the second cell down in source window 207) has a symbol with two spaces between two characters, and the spreadsheet program and/or control system may have been programmed for the TRIM function to eliminate extra spaces, or any spaces, between characters, applying the TRIM function to column 202 would result (as shown in later figures) in converting the original data shown in cell 222 (namely, “CST L”) into a consolidated format with no spaces between characters—namely, “CSTL”—which is then presented to the user in a results presenting window, such as results window 223, which would then display tentative or actual results that will be presented in place of the original, source data in column 202. In the results window 223, the same number and configuration of cells is provided as in original source data window 207, and shows a preview of the results to be presented in place of the original, source data. In some embodiments, such a preview of results is provided if sufficient time has elapsed for the control system to validate and process the function. In some embodiments, such a preview of results is provided after a user has entered an additional space after the ending character of the formula or potential formula. If a user presses the transform button 217, the data presented in the results window 223 is then shown when the spreadsheet is viewed without transformation facilitating window 203 in place, over cells of spreadsheet 111. If the transform button 217 were not yet pressed, however, any results data presented in the results window 223 is tentative, as discussed above, as may be shown by shaded, differently-colored, or another tentativeness indicator, such as tentativeness indicator 325 (set forth in the following figure). If the transform button 217 has been pressed, another, for example, bolder, green or solid black execution indicator, such as execution indicator 427 (bolder than a default results window indicator 227), may instead surround results window 223. If an entered function cannot be parsed, or otherwise yields an error, an error indicator may be presented on or about the results window 223 (not pictured). In some such embodiments, such an error indicator is an error message, and includes information related to the error. In some embodiments, where the entered function cannot be parsed or otherwise yields an error, and another, previous function within the formula entry field had been entered and was modified by the entered function, results from that previous function will remain presented. In some such embodiments, such results from such a previous function will so remain presented until the entered function is modified, becoming parsable, and is parsed by the control system.

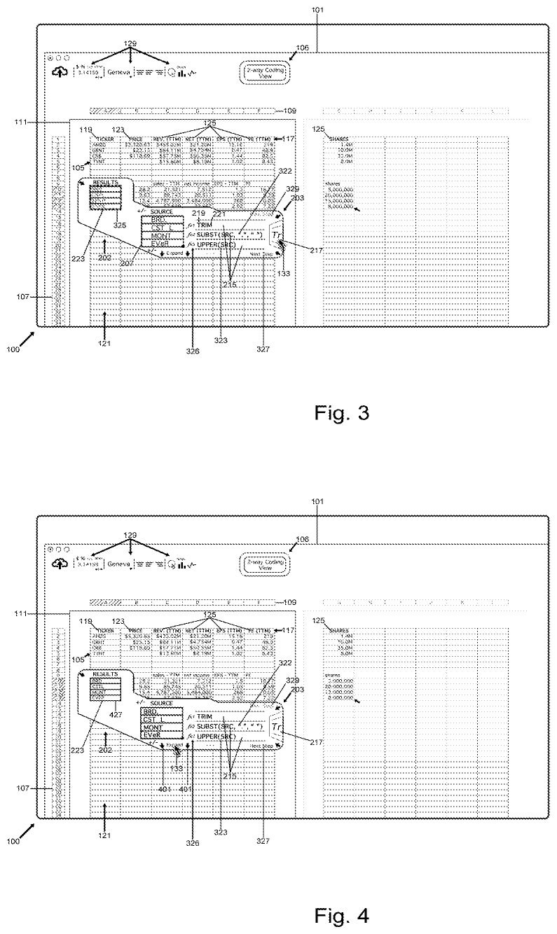

Assuming that a user has fully entered a solvable formula—in this instance, the TRIM formula—but has not yet actuated the transform button 217, FIG. 3, below, depicts what may result, in some embodiments.

FIG. 3 depicts some of the same example data and data presentation transformation tools set forth in FIG. 2, with a transformation facilitating tool 203 in an expanded format, hovering over the same example cells of spreadsheet 111, with formula 221 and several more example formulae—namely, example formula 322 and example formula 323—entered into the formula entry fields 215. As discussed above, assuming that a space has been entered after each control system-solvable formula, and/or, in some embodiments, after a short delay to conserve control system resources (e.g. 300 milliseconds), the control system may render, in results window 223, the tentative results of applying the formulae, seriatim, in the order of their occurrence in the formula entry fields (e.g., top-to-bottom, as indicated by formula identifiers 326, “fx1”, “fx2” and “fx3”). As discussed above, because the user has not actuated the transform button 217, or hit enter, or a shortcut button or keyboard entry sequence for finalizing the transformation, or otherwise indicated that the transformation should be executed, the results may be considered tentative, and presented to the user within results window 223 with a tentativeness indicator 325. For example, in some embodiments, such tentativeness indicator may be a dashed or shaded surrounding line, distinct from the appearance of results window 223 when the results of fully executed transformations are presented in results window 223. In some embodiments, such a tentativeness indicator may be of any kind that distinguishes the tentative results visually from the results of fully executed transformations, and other actions of the user interface.

By way of example, the two additional formulae, namely, example formula 322 and example formula 323, entered in formula entry fields fx2 and fx3, are also housekeeping formulae, processing the original data in cells A10 through A13 to better match the desired format. More specifically, formula 322 is a substitution function, specifying that any period (meaning the punctuation character) in the source data should be eliminated. Thus, the tentative result shown for the original data in cell A10, “BRD.” exhibits a replacement, with simply “BRD” appearing in the corresponding cell position of results window 223. Example formula 323 is understood by the control system, based on specialized programming, to command the conversion of any alphabetical characters in a lower-case format, to an upper-case format. Hence, the lower case “e” present in cell A13, and the bottom cell of source data window 207, is replaced in the corresponding cell position of results window 223 with an upper-case “E.” In some embodiments, the user may add many more, and much more complex functions, in any order, within additional fields. In some embodiments, by pressing the “Next Step” text/button 327, the list of formula entry fields would scroll downward, presenting similar, additional formula entry fields (not pictured). In such embodiments, the user could then return to a presentation of earlier entered formulae at any time, by “scrolling up,” using the “Previous Step” text/button 329. In some embodiments, a user may sort and alter the order (and order of execution) of the various formulae entered. For example, in some embodiments, a user may alter the order by clicking on one formula with pointer 133, and dragging it to a new position, above or below another formula, resulting in it being re-ordered above or below that other formula.

Next, according to some embodiments, the user has placed pointer 133 over the transform button 217, and may actuate it (e.g., by clicking), commanding the control system to execute the formulae. Embodiments related to the results of such execution will be discussed further, below.

FIG. 4 depicts some of the same example data and data presentation transformation tools set forth in FIGS. 2 and 3, with the transformation facilitating tool 203 in an expanded format, hovering over the same example cells of spreadsheet 111, with formula 221, and the several more example formulae—namely, example formula 322 and example formula 323—executed by a control system, in accordance with embodiments of the present invention. As mentioned above, now that the previously tentative results of applying example formula 221, example formula 322 and example formula 323 to original data in cells A10 through A13 have been executed by the control system, minimizing or removing transformation facilitating tool 203 from its position above cells of spreadsheet 111, such that it is no longer hovering over the spreadsheet 111, will lead to only the results shown in results window 223 appearing at positions A10 through A13 of spreadsheet 111, with no need for using additional cells of spreadsheet 111. Nonetheless, in some embodiments, all of the data and formulae, and results window 223 itself, are accessible again, merely by summoning and/or expanding transformation facilitating tool 203 again, with at least some of the same cells (set of cells 205) highlighted. The fact that the results are no longer tentative, but executed by the system, may be reinforced visually with a distinct execution indicator 427, differentiating it for a user viewing transformation facilitating tool 203. For example, in some embodiments, execution indicator 427 may be a bolder border than had appeared previously. In some embodiments, execution indicator 427 may be a differentiating color, such as green.

Next, a user has placed pointer 133 over additional user interface expansion arrows 401, and will actuate them (e.g., by clicking). The results of that actuation will be discussed in greater detail, below.

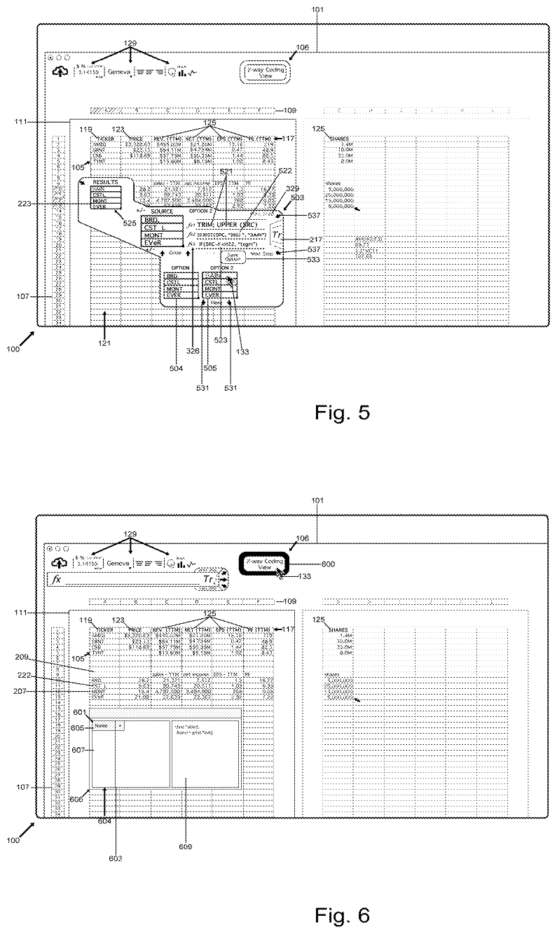

FIG. 5 depicts the same example data and data presentation transformation tools set forth in FIG. 4, above, with the transformation facilitating tool, now shown as transformation facilitating tool 503, in an even further expanded format, presenting a user with optional results window 504 and optional results window 505, in accordance with embodiments of the present invention. In addition, according to some embodiments, another example set of formulae have been entered in transformation facilitating tool 503—namely example formula 521, example formula 522 and example formula 523. In some embodiments, example formula 521 and example formula 522 correspond to one of several new optional results windows—namely, optional results window 505. In the example pictured, the first optional result window, 504, corresponds with the first set of formulae, discussed above, in reference to FIGS. 3 and 4 and, thus, contains the same resulting values as shown previously in results window 223. By clicking on (e.g., hovering pointer 133 over and depressing a mouse button of the control system creating user interface 101) additional, optional result windows provided in transformation facilitating tool 503, a user can select or enter an alternate set of formulae, and create another set of results to be executed and presented in place of the original data set forth in columns A10 through A13 of spreadsheet 111. For example, by clicking on optional result window 505, as pictured, a user may instead select the example set of formula—namely, formula 521, formula 522 and formula 523—which are then presented in the formula entry fields, and preview another resulting set of values, resulting set of values 525, created therefrom in results window 223. In formula 521, which may have been created or saved and re-accessed by the user, the user has consolidated two formulae into one, thus putting a TRIM function and an upper-case conversion function (as discussed above, with respect to formulae 221 and 323) into one (the top) formula entry field of transformation facilitating tool 503. The next formula, formula 522, is a new, substitution function, replacing any instance to which it is applied of the erroneous or outdated ticker symbol (“BRD.”) with a new ticker symbol (“BAIN”). As a result, if optional result window 505 is selected and/or executed by clicking on transform button 217, showing a preview of the results that would occur with the application of the set of formulae, as discussed above, results window 223 is also populated with a new optional resulting presentation of data, including “BAIN” in the top-most cell. The third formula, formula 523, contains a text color conversion function, referencing and conditioned on work set forth in spreadsheet 111, namely, at cell positions H19 through H22, as shown.

To extend the example, in the H19 cell of spreadsheet 111, an averaging function has been applied to cells F2 through F5 of spreadsheet 111, a column containing price-to-earnings ratios (“PE ratio”) for each of the securities set forth in cells A2 through A5. The result of that calculation is then set forth below, in cell H20, as 89.71. In the next cell down, H21, the control system has then multiplied that result in cell H20 by 1.2, to create a value 20% greater than the average PE ratio: 107.65. Thus, as a net result, the work set forth in cells H19 through H22 creates a value 20% greater than the average PE ratio for securities within the spreadsheet 111, before importing new, raw data set 127. In the example embodiment pictured, therefore, by relating formula 523 to that value, referencing the result in cell H22 within the formula code, the user then platforms off of the work from spreadsheet 111 to create the text color conversion function, which alters the presentation of data in optional results window 505 and (because window 505 has been selected by the user) results window 223, in some embodiments. In some embodiments, if the user actuates transform button 217, that presentation will also be seen in place of the original source data in cells A10 through A13 of spreadsheet 111, and instead of the results previously selected for presentation, as set forth in figures above (and in optional results window 504), upon exiting or minimizing transformation facilitating tool 503.

Such additional cell usage, optional results windows and corresponding sets of formulae as set forth in this figure may be numerous, and accessed by expanding transformation facilitating tool 503 even further, using additional actuable expansion arrows/buttons 531, in some embodiments. Any such optional results windows and corresponding formulae may be saved by the user for future access, modification and further option creation, in some embodiments. For example, in some such embodiments, by actuating a work saving button, such as option saving button 533, such optional results windows and corresponding formulae may be saved. The exact number of windows or other user interface features, and types of spreadsheet actions shown in the figure, and in other figures in this application, are merely an example of the wide range of embodiments falling within the scope of the invention. Such embodiments will be readily apparent to those of ordinary skill in the art to which this application pertains in light of the application.

To facilitate the return of expanded, hovering transformation facilitating tool 203/503 to its previous, condensed position, pictured in FIG. 1, a user may actuate GUI tool minimization arrows, such as the examples shown as GUI tool minimization arrows 537. In some embodiments, such actuation returns the transformation facilitating tool 503 to a condensed format, such as the format shown as transformation facilitating tool 103, within the user interface configuration set forth in FIG. 1, above (albeit with any selected new results from the application of a transformation now appearing in place of the original data in cells A10 through A13 of spreadsheet 111).

FIG. 6 depicts the same example data and presentation tools within a user interface as set forth above, in reference to FIG. 1, but with the 2-way coding and presentation assessment tool 106 expanded and presented to a user as expanded interface 606, in accordance with some embodiments of the present invention. As explained above, such an expansion and presentation may be caused by the user actuating a button, such as 2-way coding view button 600, in some embodiments.

Unlike conventional spreadsheet programs, a spreadsheet program implementing 2-way coding and presentation techniques in accordance with some embodiments of the present invention allows a user to view, directly access, enter and alter coding, logic, and raw data (“coding” or “the model” of the system), in some embodiments. In some embodiments, such a user may affect virtually any presented parameters of a spreadsheet or spreadsheet aspect, or other aspects of a software program (“the view” of the system). In some such embodiments, the user may so affect such parameters and aspects by using a dedicated coding entry field or other GUI module. Conversely, in some embodiments, a user can alter the coding by moving or otherwise manipulating the presented spreadsheet aspects, or other visual aspects of the user interface 101, graphically. In some embodiments, either a direct, graphical manipulation of the visual presentation, or an alteration of the underlying code, affects the other, that the coding and presentation techniques set forth herein are characterized as “2-way.” In the example embodiments provided in the figure, the coding within the module is in the python computer programming language. However, as will be readily apparent to those of ordinary skill in the art, any suitable programming may be used in implementing various embodiments of the invention.

An example of a directly user-alterable graphical element of the spreadsheet is shown as a presented visual construct 601, which may, in individual cases, be any graphical or other visual element that may be created and presented using a spreadsheet program. In the example provided in the figure, visual construct 601 includes a table 603, with one column 604 and two cells: heading cell 605 and empty data entry cell 607, directly beneath heading cell 605. As an example of a coding entry field, parallel coding window 609 is provided. Code entered by the user, or otherwise saved within the spreadsheet program (e.g., by entering it within coding window 609), and resulting in the presentation of table 603, appears within coding window 609. In some embodiments, such simplified code expressions are pre-populated in templates or other starting documents. In some such embodiments, such simplified code expressions are saved and managed by the control system implementing aspects of the present invention (e.g., according to instructions of a spreadsheet program implementing aspects of the present invention. Thus, for example, upon starting up the spreadsheet program implementing techniques of the invention, and selecting a “table” template, a user may be presented with visual construct 601 and parallel coding window 609, as shown in FIG. 6.

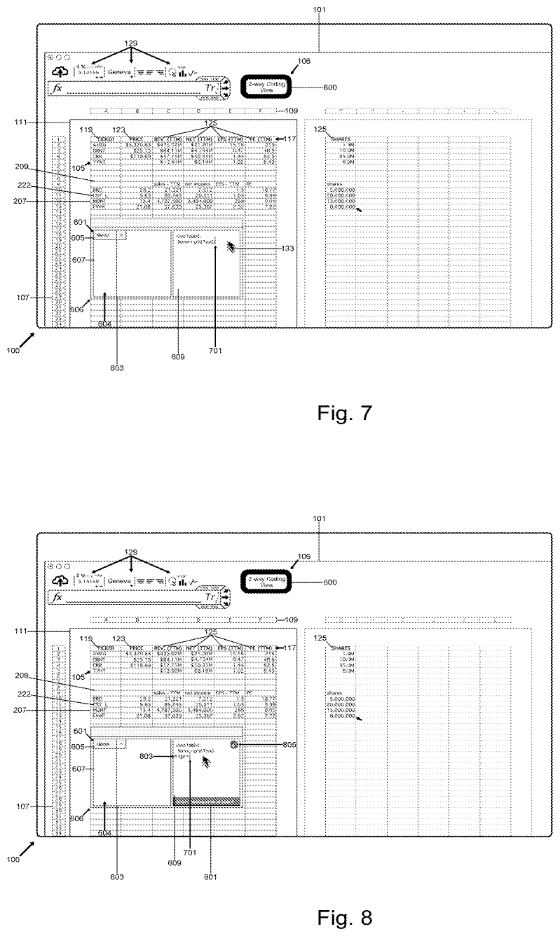

In any event, in FIG. 7, the user has “clicked in” to parallel coding window 609, e.g., by hovering pointer 133 over it and clicking on it (e.g., using a mouse or other input device). At this point, a cursor 701 appears within parallel coding window 609, indicating that any typing by the user (e.g., using a data entry device, such as a keyboard) will result in coding, or coding attempts. Such coding attempts are parsed by validation steps of the present invention, in some embodiments. In such embodiments, as code is entered within parallel coding window 609, it is parsed and/or validated by a program implementing aspects of the present invention. In some embodiments, such parsing is continuous. In some embodiments, such parsing is in real time. In some embodiments, such parsing is carried out, as pictured, after a short delay, conserving control system resources. Because that delay has not yet occurred, or another prerequisite (such as entering a space after a string of new characters) has not yet occurred, in the embodiment presented in this figure, the results of that parsing and validation process, running through parsing and other validity steps, is not yet shown. However, these and several other programmatic steps according to embodiments of the invention are discussed further, below.

FIG. 8 depicts an example subsequent result when a user enters invalid code within example parallel coding window 609. In the example provided, the user has entered the term “Age =” after the previously validated code appearing above it. Although a valid expression may ultimately be entered by the user, at this point, when the parsing and validation steps illustrated in the figure took place, the code is not parsable and valid, and cannot be processed by the computer hardware and software to produce a corresponding graphical presentation within visual construct 601. As a result, in some embodiments, as pictured, the control system produces an error message 801, within parallel coding window 609. In some embodiments, the control system may also present an in-line error indicator(s), such as the example shown as 803. In some embodiments, such an in-line error indicator may indicate which line of code was not parsable or processable, leading to the error. Any number of additional error indicators, at various locations, such as auxiliary error indicator 805, may also be provided, in some embodiments.

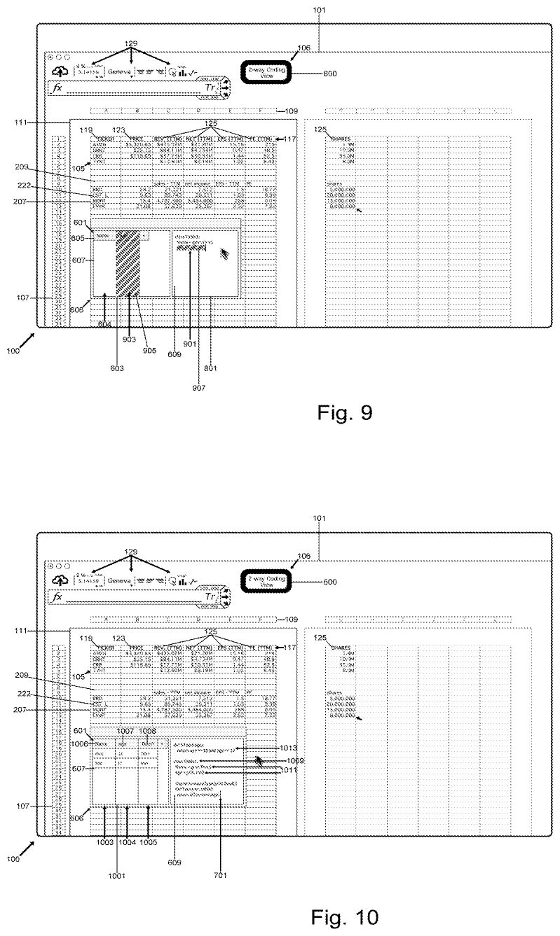

FIG. 9 depicts an example subsequent result when a user has corrected or completed an erroneous code entry, such as the exemplary code entry set forth in FIG. 8, above. By eliminating the error previously entered, completing the valid code expression 901, namely, “Age=grist.Int( )”, which is parsable and processable by the control system running the spreadsheet program implementing aspects of the present invention, the error message has been discontinued, and is no longer displayed within parallel coding window 609, in the example embodiment provided. As a result, according to some embodiments, the visual construct 601 has been updated, in real time, to display the result of that valid coding: a new column 903 of table 603, with the heading “Age.” In addition, a different visual indicator (e.g., cell shading 905) now appears on or about the new aspects of the visual construct created by newly validated code 901, indicating to a user that it has been successfully created by the control system. Another visual indicator (e.g., highlighting 907) also appears on or about the newly validated code entry 901 in some embodiments, indicating to the user that the code has been successfully validated by the control system.

FIG. 10 depicts another, similar example graphical element (table 1001) and the implementation of an example helper function within the 2-way coding view of the user interface aspects of the present invention. As with table 603, table 1001 includes columns—namely, column 1003, column 1004 and column 1005. In some embodiments, each such column has headings, such as the example heading 1006 (“Name”), example heading 1007 (“Age”) and example heading 1008 (“Teen?”). Also as with table 603, the parallel coding view reveals direct visual coding elements, such as example coding element 1009, which calls for the creation of a table, and example coding elements 1011, which call for the creation of columns and column headings. In addition, an additional example helper function 1013 has been entered by the user, which conditions the presentation of third column, 1005. In the example provided, helper function 1013 creates a numerical range, from the integers 13 through 19, and defines any number from the column headed “Age” within that range as “true.” As a result, tables such as 1001 can reflect complex intermediate programming that conditions, but does not independently create or call for the creation of, visual elements presented in visual construct 601, in some embodiments.

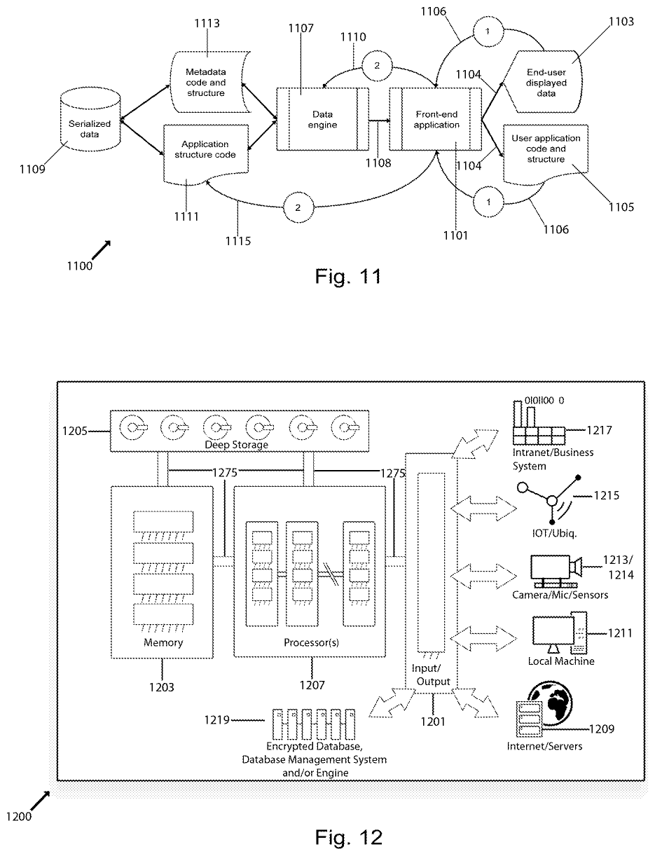

FIG. 11 is a structural diagram of some example system components 1100, in accordance with embodiments of the invention, which may be used to carry out 2-way coding aspects, such as the example 2-way coding embodiments set forth above. As mentioned above, a spreadsheet application running on computer hardware (such as the control system set forth below, in reference to FIG. 12) may be modified or otherwise specialized to create any of the aspects of the invention set forth in this application, in some embodiments of the invention. The example provided in this figure is merely an example of the many different possible variations for systems and methods implementing aspects of the invention set forth in this application, as will be readily apparent to those of ordinary skill in the art.

Generally speaking, in some embodiments, such a control system may have components including the presentation of a graphical user interface (“GUI”), structured in accordance with aspects of the invention set forth above. In some embodiments, the GUI of the system may be thought of as part of the front-end application, 1101, of the system and may include data 1103 displayed to an end user (e.g., the presented visual construct 601, discussed above) and presented code and structure 1105 of the spreadsheet software, editable by the user (e.g., the parallel coding window 609, discussed above). Thus, both the data 1103 displayed to an end user, and the presented code and structure 1105 are generated by the front-end application 1101, and presented to a user, as shown by origination arrows 1104, in some embodiments. However, as discussed above, data 1103 and application code and structure 1105 may also be manipulated and altered by the user, in some embodiments, allowing a user to change them, within the application, as shown by command/data alteration arrows 1106.

Supporting the delivery of such front-end application aspects, a data engine 1107 is provided in some embodiments. In some embodiments, the data engine 1107 may generate processed data in formats used by the front-end application to deliver the GUI, as set forth above, and illustrated by data path arrow 1108. Conversely, the front-end application may alter data or give other commands to be carried out by the data engine, in some embodiments, as shown by data flow arrow 1110. As set forth in greater detail below, serialized data 1109 may be stored within the system (e.g., raw data) as a source of application structure code 1111, in some embodiments, and may include metadata code and structure 1113, in some embodiments. While both the metadata code and structure 1113 and application structure code 1111 may be generated by, and supplied to, the data engine 1107 (which then supplies processed data to the front-end application) in some embodiments, in some embodiments, the application structure code may also be directly linked to the front-end application, receiving programmatic input (structural application changes) from the application (and computer hardware of the control system) with no intermediate processing by the data engine, as shown by data flow arrow 1115.

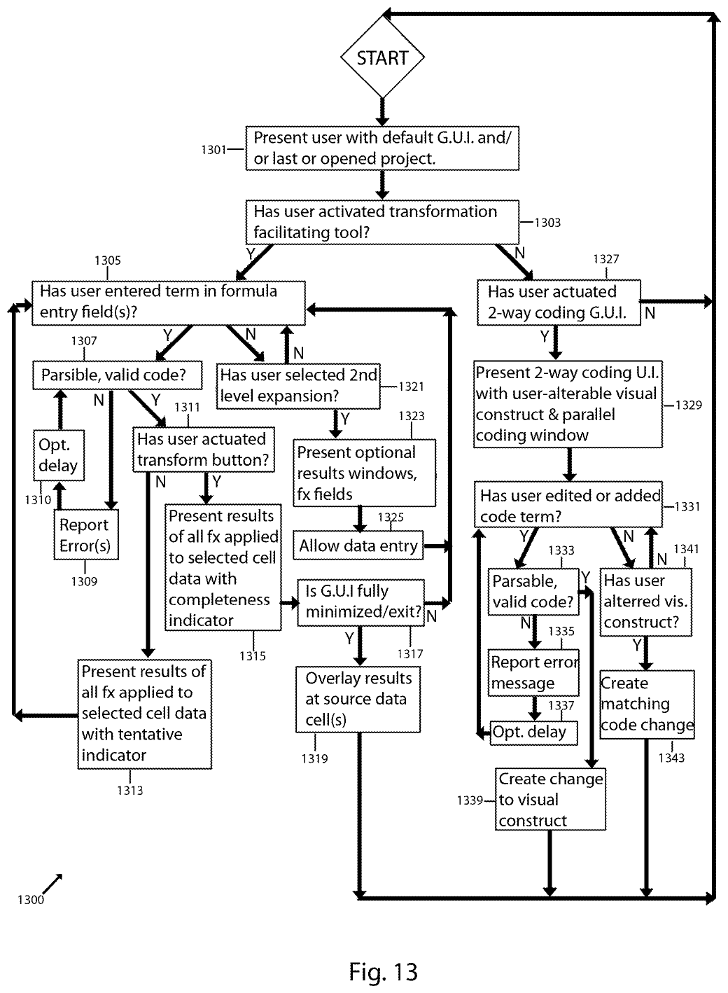

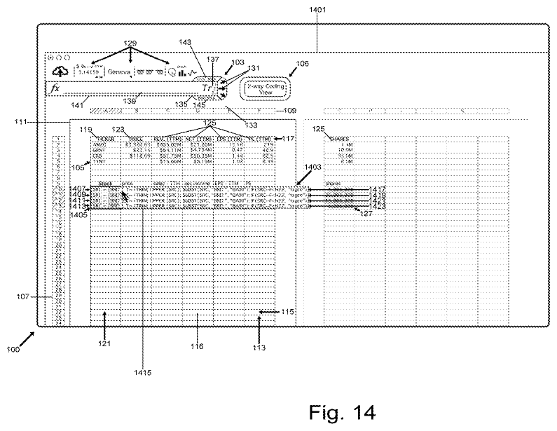

FIG. 12 is a schematic block diagram of some example elements of an example control system 1200, preferably incorporating a non-transitory machine-readable medium, that may be used to implement various aspects of the present invention, some of which aspects are described in reference to FIGS. 1-11, above, and FIGS. 13 and 14, below. The generic and other components and aspects described herein are not exhaustive of the many different control systems and variations, including a number of possible hardware aspects and machine-readable media, that might be used, in accordance with embodiments of the invention. Rather, the control system 1200 is described here to make clear how aspects may be implemented.

Among other components, the control system 1200 may include an input/output device 1201, a memory device 1203, longer-term, deep data storage media and/or other data storage device 1205, and a processor or processors 1207. The processor(s) 1207 is (are) capable of receiving, interpreting, processing and manipulating signals and executing instructions for further processing and for output, pre-output and/or storage in and outside of the control system. The processor(s) 1207 may be general or multipurpose, single- or multi-threaded, and may have a single core or several processor cores, including microprocessors. Among other things, the processor(s) is (are) capable of processing signals and instructions for the input/output device 1201, to cause a user interface to be provided or modified for use by a user on hardware, such as, but not limited to, a personal computer monitor or terminal monitor with a mouse and keyboard and presentation and input-facilitating software (as in a GUI), or other suitable GUI presentation system.

For example, “window” and spreadsheet program “tool” presentation user interface aspects may present a user with the option to command other aspects of the control system to process and present data, and underlying formulas and coding to a user, and/or provide or deny access to a user, including data and code editing access, through the user interface techniques set forth in this application, and to carry out any other actions set forth in this application for a control system. The processor(s) 1207 is/are capable of processing instructions stored in memory devices 1205 and/or 1203 (or ROM or RAM), and may communicate via system buses 1275. Input/output device 1201 is capable of input/output operations for the control system 1200, and may include and communicate through innumerable input and/or output hardware, and innumerable instances thereof, such as a computer mouse(s), or other sensors, actuator(s), communications antenna, keyboard(s), smartphone(s) and/or PDA(s), networked or connected additional computer(s), camera(s) or microphone(s), mixing board(s), reel-to-reel tape recorder(s), external hard disk recorder(s), additional movie and/or sound editing system(s) or gear, speaker(s), external filter(s), amp(s), preamp(s), equalizer(s), filtering device(s), stylus(es), gesture recognition hardware, speech recognition hardware, computer display screen(s) or touch screen(s). Such a display device or unit and other input/output devices could implement a program or user interface created by machine-readable means, such as software, permitting the system and user to carry out the user settings and other input discussed in this application. 1201, 1203, 1205, and 1207 are connected and able to send and receive communications, transmissions and instructions via system bus(ses) 1275. Deep storage media device 1205 is capable of providing mass storage for the system, and may be a computer-readable medium, may be a connected mass storage device (e.g., flash drive or other drive connected to a U.S.B. port or Wi-Fi) may use back-end or cloud storage over a network (e.g., the Internet) as either a memory backup for an internal mass storage device or as a primary memory storage means, or may simply be an internal mass storage device, such as a computer hard drive or optical drive.

Generally speaking, the system may be implemented as a client/server arrangement, where features of the invention are performed on a remote server, networked to the client and made a client and server by software on both the client computer and server computer. System 1200 is capable of accepting input from any of those devices and systems 1209-1219, and modifying stored data within them and within itself, based on any input or output sent through input/output device 1201.

Input and output devices may deliver their input and receive output by any known means, including, but not limited to, any of the hardware and/or software examples shown as 1209-1219.

While the illustrated system example 1200 may be helpful to understand the implementation of aspects of the invention, any suitable form of computer system known in the art may be used—for example, a simpler computer system containing just a processor for executing instructions from a memory or transmission source. The aspects or features set forth may be implemented with, and in any combination of, digital electronic circuitry, hardware, software, firmware, modules, languages, approaches or any other computing technology known in the art, any of which may be aided with external data from external hardware and software, optionally, by networked connection, such as by LAN, WAN or the many connections forming the Internet. The system can be embodied in a tangibly-stored computer program, as by a machine-readable medium and propagated signal, for execution by a programmable processor. The method steps of the embodiments of the present invention may be performed by such a programmable processor, executing a program of instructions, operating on input and output, and generating output and stored data. A computer program includes instructions for a computer to carry out a particular activity to bring about a particular result, and may be written in any programming language, including compiled and uncompiled and interpreted languages and machine language, and can be deployed in any form, including a complete program, module, component, subroutine, or other suitable routine for a computer program.

FIG. 13 is a process flow diagram, setting forth several example steps 1300 that may be undertaken by a control system (such as the exemplary control system set forth above, in reference to FIG. 12) implementing example embodiments of the present invention (e.g., through software executed on the control system hardware described throughout this application).

Beginning with step 1301, the control system first presents a user with a graphical user interface (“G.U.I.”) on computer hardware (e.g., a display), in a default arrangement of configured user interface elements, such as the G.U.I. set forth above, in reference to FIG. 1. In addition, and if the user has opened an existing spreadsheet, document or other previously-saved project, the control system may also present various document elements (such as data organized in a matrix of cells within a spreadsheet format, as also depicted in FIG. 1). The control system next proceeds to step 1303, in which it determines whether a user has activated (for example, by expanding it or clicking on it, as discussed above) a transformation facilitating tool presented in the G.U.I., such as exemplary transformation facilitating tool 103, discussed above. If so, the control system proceeds to step 1305, in which it determines whether a user has entered a term, or string of characters or terms, within one of the formula entry fields of the transformation facilitating tool (such as entry fields 215, set forth above). If so, the control system proceeds to step 1307, in which it determines whether the term or string of characters or terms is a parsable, valid code expression, which can be run by the control system (for example, to create results as applied to highlighted or selected source data in cells of the spreadsheet, as set forth above). If not, the control system may proceed to step 1309, in which it reports an error based on the nature of the coding error determined to exist by the control system (e.g., syntax error, reference error, or incomplete code expression or other parsing error). The nature of the error may be similar to those depicted and discussed in FIG. 8, above. To avoid wasting system resources, the control system may next implement a delay, in step 1310, before returning to step 1307—allowing a user to enter additional code. In some embodiments, such a delay (e.g. 500 milliseconds) may be implemented at any other transition between steps, for similar reasons (e.g. between step 1305 and 1307, above). In general, the steps set forth in reference to FIG. 13 may be conducted in a wide variety of orders, and with or without various steps set forth herein, and with or without additional steps, while implementing aspects of the present invention, and as will be readily apparent to those of ordinary skill in the art. The exact order and number of steps set forth herein are exemplary only. For example, in some embodiments, a step in which the control system determines whether the user has entered a space after a character or group of characters, may be added, and/or a delay may be added, between steps 1305 and 1307 (or between any other steps set forth in this figure).

Returning to step 1307, if the control system determines that the entry currently entered is a parsable, valid code expression, it next proceeds to step 1311, in which it determines whether a user has actuated a transform button of the transformation facilitating tool, such as exemplary buttons 137 or 217, set forth above, have been actuated by the user. If not, in step 1313, the control system may still present tentative results (with a tentativeness indicator of a results presentation window, as discussed above in this application), which results are generated from the application of the code entered by the user (e.g., a series of formulas, as set forth above) to the source data in cells selected by the user and/or a set of additional spreadsheet cells, as also discussed above. The control system may then return to step 1305.

If, at step 1311, the control system instead determines that a user has pressed a transform button (or, in some embodiments, hit enter, or a particular shortcut key designated for triggering execution of a transformation, as discussed above), the control system proceeds to 1315, in which presented results (similar in nature to the results set forth above, in reference to step 1313) are instead presented with a different, bolder, green or other visual indicator of full execution or a lack of tentativeness (a.k.a., completeness) of the results presented (e.g., within or about a results window, such as those set forth above). The control system next proceeds to step 1317, in which it determines whether the user has minimized or exited the transformation facilitating tool (e.g., leading it to be no longer embedded in, hovering over, or otherwise blocking cells within the spreadsheet from view.) If so, the control system then proceeds to step 1319, in which the cells initially holding the source data processed by formula(ae) using the transformation facilitating tool are then overlaid with, and present, the results previously set forth in the results window, as set forth above. The control system then returns to the starting position.

If, at step 1305, the user has not entered a formula (or, in some embodiments, a new formula or formula change) in a formula entry field of the transformation facilitating tool, the control system may next determine, in step 1321, whether the user has actuated a G.U.I. aspect commanding the control system to expand the transformation facilitating tool another time, or to a greater degree (meaning, for example, that the user may have actuated arrows 401, set forth above). If so, the control system may, in step 1323, present additional, optional results windows, with different, additional corresponding formula fields, as discussed. Of course, a user may then make entries in any of those fields—as discussed at length elsewhere in this application—in proceeding step 1325, before returning to step 1305.

Turning back to step 1303, if the control system instead determined that a user has not actuated the transformation facilitating tool, it may next proceed to step 1327, in which it determines whether the user has actuated a two-way coding G.U.I., such as the 2-way coding G.U.I. set forth above, in reference to FIGS. 6 et seq., which is actuated by view button 600. (Of course, as alluded to above, step 1327 et seq. could be performed before steps 1305 et seq., among virtually infinite variations in various embodiments within the scope of the invention, and the exact order provided is exemplary only.) If a user has actuated the 2-way coding G.U.I. controlled by the control system, the control system proceeds to step 1329, in which it presents that GUI to the user, as pictured in FIG. 6, above. As discussed in reference to FIG. 6 et seq., such a 2-way coding G.U.I. preferably comprises a user-alterable visual construct, with graphical elements viewable by a user, and a parallel field, such as a window, for entering software code. Also as discussed above, changes made by a user manipulating either of those two G.U.I. components may impact aspects of the other component (hence the term, 2-way), as reflected in the further steps, below.

In step 1331, the control system may determine whether a user has added code, or otherwise added code displayed within, the parallel coding window. If so, the control system may proceed to step 1333, in which it tests the validity and parsability of the code, as discussed in other contexts above and, if the code is not valid or parsable, reports an error message or messages (such as any or all of the error messages discussed above, and especially in reference to FIG. 8, above) in step 1335. As with step 1310, the control system may then enter a delay phase in subsequent step 1337, set at some measure to balance usability and management of system resources (e.g., between 50 and 500 milliseconds), before returning to step 1331. If, instead, at step 1333, the control system determined that a valid coding statement had been entered, it may proceed to render the changes to the visual construct (such as construct 601, above) to reflect commands in the new code, in step 1339. The control system may then return to the starting position.

If a user has not added code, at step 1331, the control system may proceed to step 1341, in which it determines whether a user has altered the visual construct by direct manipulation (e.g., actuating tools within the construct for altering it), in which case matching code changes, which would create the same changed visual construct, are then automatically created by the control system in the parallel coding window, in step 1343.

The control system then returns to the starting position.

The steps set forth herein are illustrative, not exhaustive, of the many different number and sequences of steps that may be executed to carry out aspects of the present invention, which are virtually unlimited. As will be readily apparent to those of ordinary skill in the art, all such alternate orders, numbers, partial sequences, or any other part of the techniques fall within the scope of the invention. Although some steps have been listed as “optional,” for ease of understanding, above, it should be understood that other steps may also be omitted or included in particular embodiments carrying out aspects of the invention.

FIG. 14 depicts exemplary data processing and presentation tools within a user interface 1401, similar in nature to some tools set forth above, but with a different form factor, in accordance with aspects of the present invention. Some of the tools, such as, but not limited to, the data transformation facilitating tool 103, and the 2-way coding and presentation assessment tool 106, are as described in FIG. 1 et seq, above, of this application. However, a new transformation facilitating tool, now shown as 1403, has a more condensed format, hovering directly over four source data cells 1405 (raw data set 127, Cells A10-A13) to transform the data held therein. In some embodiments, and as shown, transformation facilitating tool 1403 may have the same height, or substantially the same height, and/or may be the same as, data cells 1405, and, thus, will not obscure any other part of spreadsheet 111 above and below the spreadsheet rows 1407, 1409, 1411 and 1413 (addressed as A10 through A13, within the spreadsheet). However, in some such embodiments, transformation facilitating tool 1403 may nonetheless extend beyond data cells 1405 laterally (to the right-hand side, as in the embodiment shown), at least while a user is editing functions, references or other coding-oriented entries within transformation facilitating tool 1403. In some other embodiments, however, transformation facilitating tool 1403 may hover only over source data cells 1405, not so extending.

In other words, rather than include or simultaneously present a separate source data window (such as window 207, discussed with reference to FIG. 2 of this application) along with differently-positioned formula entry fields (such as 215), and a differently-positioned results window (such as 223), transformation facilitating tool 1403 instead includes only a single window, 1415, at least partially coinciding (and, in some embodiments, entirely coinciding) with the area occupied by source data cells 1405. Once transformation facilitating tool 1403 has been activated (which may be accomplished, as with other transformation facilitating tools set forth in this application, by clicking on expansion arrows 131 or by pressing a designated shortcut key or conducting a gesture, as discussed above) and appears above the data cells highlighted within spreadsheet 111 (namely, data cells 1405) window 1415 allows a user to enter formulas in the same area as source data cells 1405. In some embodiments, each cell of cells 1405 defines a formula entry field, such as fields 215, in which a series of transformative functions, such as those set forth above in this application, may be entered and applied to the source data held within the cell. In other embodiments, a single function so entered may be applied to data within each of data cells 1405, the user having only to enter it once (e.g., in line 1417) to have it automatically entered and applied to data within each cell (as shown by the functions shown in lines 1419, 1421 and 1423, which may be automatically populated upon entering the formula in line 1417).

Upon completing such entry of formulas, within window 1415 (and, in some embodiments, upon clicking on transform button 137 and/or the “Enter” button on a keyboard, or by pressing another entry or activation tool or shortcut) window 1415 may then disappear, and the resulting values of the application of the entered formulas then appear, in place of the source data originally in cells 1405, and within the area of cells 1405 (and, in some embodiments, only within that area). However, in some embodiments, a user may still, even after such execution of the formulas, quickly “toggle” between a presentation of the resulting (transformed) data values (such as the results shown in window 223, discussed above) and the original, source data in cells 1405—for example, by clicking on cells 1405, or by pressing a shortcut key on a keyboard or other user interface device of the computer hardware and control system.

Furthermore, in some embodiments, a user can undo (and then redo) the application of any entered formula, in any formula entry field set forth in the present invention in a single action or step—for example, with dedicated GUI aspects, such as a button, for undoing the application of any formula(s) of an executed transformation, and/or a for redoing the application of such formula(s), after such undoing (including, but not limited to, a transform button, as set forth in the present application.)

1. A user interface tool comprising computer hardware, comprising:
a window comprising at least one data entry field(s) and at least one command-initiating control(s);
wherein each of said at least one command-initiating control(s) is configured to be linked and applied to data entered within at least one cell of a plurality of cells organized in columns and rows of a spreadsheet;
wherein said data entry field(s) does not comprise said at least one cell of a plurality of cells organized in columns and rows of a first spreadsheet; and
wherein said data entry field(s) does not comprise any other cell of any other spreadsheet.

2. The user interface tool of claim 1, wherein each of said data entry field(s) is configured to receive a formula to be applied to said data entered within at least one cell of a plurality of cells organized in columns and rows of a spreadsheet.

3. The user interface tool of claim 2, wherein each of said at least one command-initiating control(s) is configured to apply said formula to said data entered within at least one cell of a plurality of cells organized in columns and rows of a spreadsheet.

4. The user interface tool of claim 1, wherein said at least one command-initiating control(s) is a single command-initiating control.

5. The user interface tool of claim 1, wherein said at least one command-initiating control(s) are multiple command-initiating controls.

6. The user interface tool of claim 1, wherein said at least one command-initiating control(s) is a button, actuable by a pointer.

7. The user interface tool of claim 1, wherein the at least one command-initiating control(s) is configured to generate and present output data within said spreadsheet.

8. The user interface tool of claim 7, wherein said at least one command-initiating control(s) is configured to present said output data in said at least one cell of a plurality of cells organized in columns and rows of a spreadsheet.

9. The user interface tool of claim 8, wherein said at least one command-initiating control(s) is configured to:
(a) hide said data entered within at least one cell of a plurality of cells organized in columns and rows of a spreadsheet; and
(b) present said output data over said data entered within at least one cell of a plurality of cells organized in columns and rows of a spreadsheet.

10. The user interface tool of claim 1, wherein the user interface tool is encoded within a spreadsheet program.

11. A spreadsheet system comprising computer hardware and a non-transitory machine-readable medium, comprising instructions configured to create:
spreadsheet(s) with a plurality of cells organized in columns and rows;
a user interface tool, comprising at least one data entry field(s) and at least one command-initiating control(s);
wherein each of said at least one command-initiating control(s) is configured to be linked and applied to data entered within at least one cell of a plurality of cells organized in columns and rows of a spreadsheet;
wherein said data entry field(s) does not comprise said at least one cell of a plurality of cells organized in columns and rows of a first spreadsheet; and
wherein said data entry field(s) does not comprise any other cell of any other spreadsheet.

12. The spreadsheet system of claim 11, wherein each of said data entry field(s) is configured to receive a formula to be applied to said data entered within at least one cell of a plurality of cells organized in columns and rows of a spreadsheet.

13. The spreadsheet system of claim 11, comprising a second user interface tool, wherein said second user interface tool comprises a 2-way coding window.

14. The spreadsheet system of claim 13, wherein the 2-way coding window comprises:
(i) a user-alterable visual construct; and
(ii) a coding window.

15. The spreadsheet system of claim 14, wherein said user-alterable visual construct is created by coding entered within said coding window.

16. The spreadsheet system of claim 15, wherein the system is configured to parse code entered within said coding window.

17. The spreadsheet system of claim 16, wherein the system is configured to present an in-line error message when said coding is parsed and parsing reveals a coding error.

18. A method for transforming data within cells of spreadsheet, comprising the following steps:
procuring a user interface tool, comprising:
a window comprising at least one data entry field(s) and at least one command-initiating control(s);
wherein each of said at least one command-initiating control(s) is configured to be linked and applied to data entered within at least one cell of a plurality of cells organized in columns and rows of a spreadsheet;
wherein said data entry field(s) does not comprise said at least one cell of a plurality of cells organized in columns and rows of a first spreadsheet; and
wherein said data entry field(s) does not comprise any other cell of any other spreadsheet.

19. The method for transforming data within cells of spreadsheet of claim 18, comprising the following additional step:
applying said user interface tool to data within a spreadsheet.
